(19) United States
(12) Patent Application Publication
(10) Pub. No.: US 2009/0094837 A1
(43) Pub. Date: Apr. 16, 2009

(54) Flush Cutter

(75) Inventors: Thomas Schandelmeier, St. Georgen (DE); Otmar Karle, Vorstetten (DE)

Correspondence Address: HARNESS, DICKEY & PIERCE, P.L.C., P.O. BOX 828, BLOOMFIELD HILLS, MI, 48303, US

(73) Assignee: WIHA WERKZEUGE GmbH, Schonach (DE)

(21) Appl. No.: 12/086,807

(22) PCT Filed: Dec. 21, 2006
(86) PCT No.: PCT/EP2006/012378

§ 371 Date: Jun. 19, 2008

(30) Foreign Application Priority Data
Dec. 22, 2005 (DE) 10 2005 063 218.1
Sep. 28, 2006 (DE) 10 2006 046 101.0

(51) Int. Cl. B25F 3/00; B25B 7/06

(52) U.S. Cl. 30/134; 81/411

(57) ABSTRACT

A flush cutter, having a first gripper part, having a first blade part comprising a blade, a second gripper part, comprising a second blade part having a blade, a joint pivot-connecting the blade parts and having handle elements associated with the blade parts.

It is provided that the blades of the first and second blade parts have at least two cutting sections, wherein a first cutting section, which is preferably arranged adjacent to the joint, or directly abuts to the same, respectively, having a first cutting edge, which is formed by means of two cutting surfaces extending toward each other in a V-shaped manner, and which is arranged at a distance to an exterior surface of the blade part, and a second cutting section, which is preferably arranged at a distance to the joint, and adjoins the first cutting section on the side facing away from the joint, having a second cutting edge, comprising two cutting surfaces extending toward each other in a V-shaped manner, of which one of them coincides with the exterior surface of the blade part.

The invention relates to a flush cutter having a first and a second gripper part embodied as blade parts, and having a blade. The blade parts are pivot-connected by means of a joint, and have associated handle elements.

Pliers embodied as flush cutters are known. They serve to cut off wire, and such. Among other things, wires must be cut off at a desired length for the realization of electric installations. Often, varying wire diameters must also be processed, or dealt with, respectively. For this purpose, different flush cutters are utilized, which are matched to the cutting of wires having different diameters. This is tedious and time-consuming.

It is therefore the object of the invention to create a flush cutter that simplifies work associated with electric installations, and such.

In order to solve this problem, the invention provides a flush cutter having the characteristics stated in claim 1. The flush cutter has two gripper parts, which are embodied as a first and as a second blade part, and have blades. The blade parts are pivot-connected by means of a joint. The flush cutter is completed by means of handle elements associated with the blades. The flush cutter is characterized in that the blades of the first and of the second blade parts have at least two cutting sections, which are configured differently, and are matched to the cutting of wires having different diameters. For this purpose a first cutting section is provided, which is preferably arranged near the joint, or directly abuts to the same. The greatest cutting forces can be realized at this location. This first cutting section has a first cutting edge that is formed by means of two cutting surfaces extending toward each other in a V-shaped manner, namely by means of the cutting line of the two cutting surfaces. The first cutting edge is at a distance to an exterior surface of the blade part. The exterior surface of the blade part is, for example, the base of the flush cutter, which usually has a recess at its front, which can receive cut off wire ends. The flush cutter is characterized by a second cutting section, which is preferably arranged at a distance to the joint, and adjoins the first cutting surface on the side facing away from the joint. The second cutting section has a second cutting edge, which comprises two cutting surfaces extending toward each other in a V-shaped manner, wherein one of the cutting edges overlaps the exterior side of the blade part. The cutting surfaces are not symmetric, but instead are wedge-shaped overall. This ensures that one of the cutting surfaces of the exterior surface of the blade part is formed so that the second cutting edge is practically positioned in the plane of the exterior surface. Thus it is possible to place the flush cutter on a surface, and to cut any wire ends protruding over the same so that they are practically flush with the surface.

Further embodiments are obvious from the sub-claims.

The invention is explained in further detail below based on the drawings. They show:

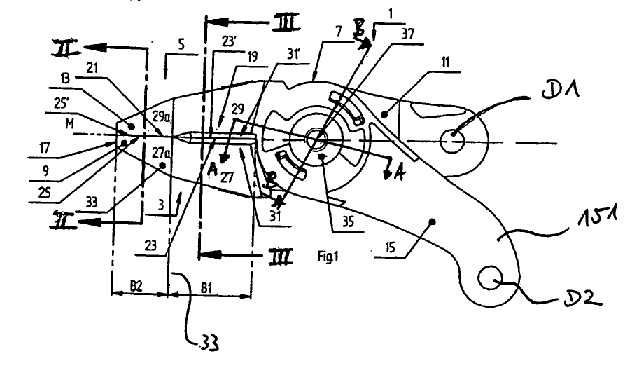

FIG. 1 the front part of a flush cutter, namely a first and a second gripper part;

FIG. 2 a cross-section across the flush cutter along the line II-II as illustrated in FIG. 1;

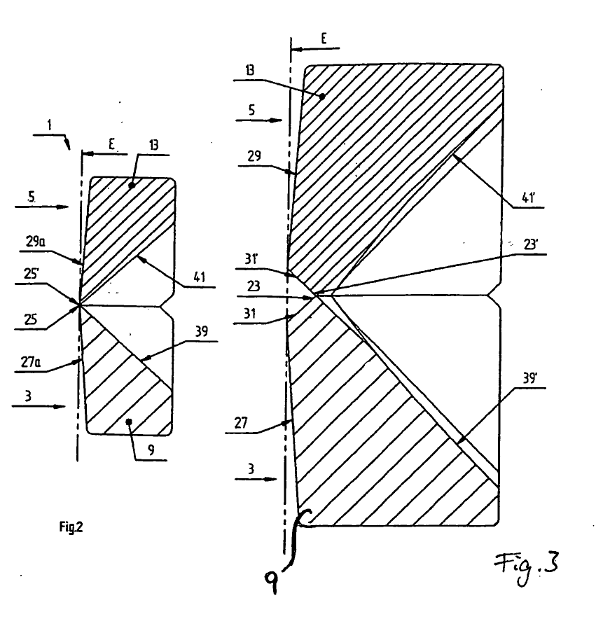

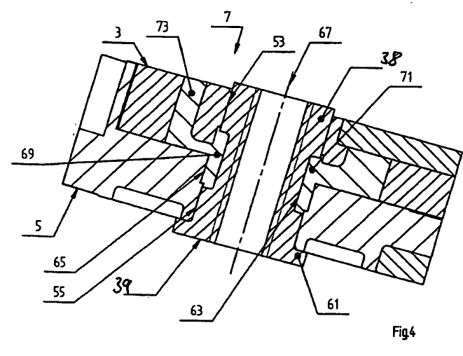

FIG. 3 a cross-section across the flush cutter along the line III-III drawn in FIG. 1;

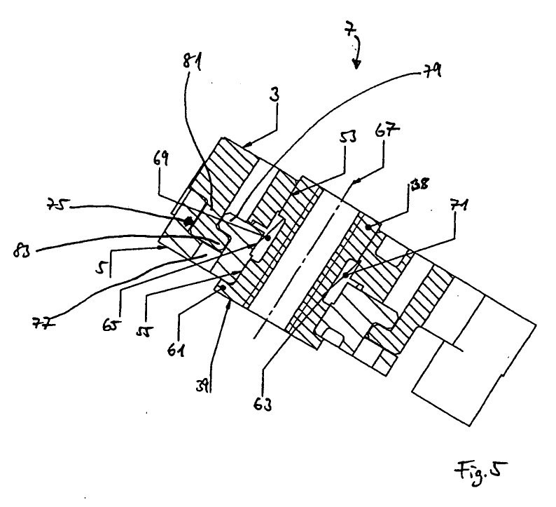

FIG. 4 a cross-section across the joint of the flush cutter in a plane, in which the center axis of the joint is positioned, and

FIG. 5 a section across the joint, which section is positioned in a twisted plane as opposed to FIG. 4, which extends through the center axis of the joint.

The front part of the flush cutter 1 illustrated in FIG. 1 has a first gripper part 3 and a second gripper part 5, which are connected to each other by means of a joint 7.

The first gripper part 3 has a first blade part 9 and a retaining arm 11, the second gripper part 5 has a second blade part 13 and an actuator 15. FIG. 1 illustrates that the retaining arm 11 is positioned opposite of the first blade part 9, and that the actuator 15 is positioned opposite of the second blade part 13, and that the joint 7 is arranged between the ends of the gripper parts 3 and 5.

A first handle element engages into the retaining arm 11, and a second handle element engages into the actuator 15. FIG. 1 shows that the first and second gripper parts 3 and 5 are embodied symmetrical to a center axis M. The retaining arm 11 and the actuator 15 may also be embodied symmetrical to the center axis. In the embodiment of the flush cutter 1 shown in this example, handle elements, which are not illustrated, engage into the gripper parts 3 and 5, or into the retaining arm 11, and the actuator 15, respectively, wherein the handle elements are connected to each other via a so-called parallelogram joint. If the handle elements are displaced toward each other at a maximum, the gripper parts 1 and 5 are displaced into the functional position illustrated in FIG. 1, i.e. in the closed position of the flush cutter 1. A spreading apart of the handle elements results in an opening of the flush cutter 1. This is known both for conventional grippers having handle elements that are embodied symmetrical to the center axis M, and for grippers having a parallelogram joint.

FIG. 1 illustrates that the blade parts 9 and 13 taper in a first area B1 from the joint 7 in the direction of the front end 17 of the flush cutter 1. In the second area B2 facing the front end 17, the blade parts 9 and 13 also taper, however the tapering angle is greater than in the first area B1. In the first area B1, which is arranged near the joint 7, or which adjoins the same directly, the blade parts 9 and 13 have a first cutting section 19, and a second cutting section 21 in the second area B2 positioned near the front end 17.

In the first cutting section 19 the first cutting element 9 has a first cutting edge 23 and a second cutting edge 25 in the second cutting section 21. Accordingly, the second blade part 13 in the first cutting section 19 is equipped with a first cutting edge 23′, and with a second cutting edge 25′ in the second cutting section 21.

The bottom view according to FIG. 1 illustrates the exterior surfaces 27 and 29 of the first blade part 9 and 13, which are facing the viewer. The exterior surface 27 ends in the first cutting edge 23 across a first cutting surface 31, and drops away from the exterior surface 27 in the direction of the first cutting edge 23. Accordingly, a first cutting surface 31′ of the second blade part 13 drops off from the exterior surface 29 in the direction of the cutting edge 23′. The two first cutting surfaces 31, 31′ thus form a quasi V-shaped groove in the exterior surface 27, 29 of the two blade parts 9 and 13 in the first cutting surface 19.

In the front area B1, e.g. in the area of the second cutting edges 25, 25′ it can be seen that the cutting edges 25, 25′ directly abut against each other, and are positioned in the exterior surface 27, 29 of the blade parts 9 and 13.

The exterior surfaces 27a of the first blade part 9 and 29a of the second blade part 13 can be seen to the left of a line 33, which extends perpendicular to the center axis M. The exterior surfaces 27a and 29a drop off the line 33 in the direction toward the front end 17 of the flush cutter 1. The thickness of the blade parts 9 and 13 is reduced from the joint 7 in the direction of the front end 17 of the flush cutter 1, wherein the invention preferably provides that the tapering angle is smaller in the first area B1 near the joint 7, than in the second area B2 of the pliers embodied as a flush cutter 1 that is positioned near the front end 17.

The joint 7 has a joint bolt 35 extending perpendicular to the image plane of FIG. 1, which has a central through hole 37 in this example. The joint bolt 35 passes through holes in the first and second gripper parts 3 and 5, and pivot-connects the same to each other. The joint bolt 35 is fixed in the joint 7 by means of a preferably injected plastic ring in the joint 7 such that it can no longer fall out of the through holes. Simultaneously, it is ensured in a suitable manner that the plastic ring reduces the friction between the joint bolt 35 and the gripper parts 3 and 5 on one hand, and between the gripper parts 3 and 5 among each other, on the other hand.

The handle elements, not illustrated, which are attached to the retaining arm 11 and the actuator 15, are preferably also injection-molded. For this purpose it is of advantage, if the plastic ring is injected into the joint 7 simultaneously with the injection molding of the handle elements. For this purpose different plastic materials may also be used for the ring and/or for the handle elements, and/or the plastic ring and the handle elements can be realized using the so-called two-component injection molding method.

The gripper parts 3 and 5 are preferably realized of metal, particularly in the course of the MIM method, the so-called metal molding injection method, or the metal powder injection molding method.

The cross-section across the flush cutter 1 illustrated in FIG. 2 shows the first gripper part 3 and the second gripper part 5, more precisely, the blade part 9 of the first gripper part 3 and the blade part 13 of the second gripper part 5. The exterior surface 27a of the first gripper part 3 and the exterior surface 29a of the second gripper part 5 can also be seen.

The sectional view according to FIG. 2 shows that the gripper parts 3 and 5 are embodied symmetrical to each other. The second cutting edges 25 and 25′ are positioned in the contact area of the first blade part 9 of the first gripper part 3 and of the second blade part 13 of the second gripper part 5. A cutting surface 39 drops off from the cutting edge 25 toward the right of the cutting surface 39. Inversely, a cutting surface 41 rises from the cutting edge 25′ toward the top. It is shown that the cutting edges 25 and 25′ are formed by means of two surfaces extending toward each other in a V-shaped manner: the cutting edge 25 across the intersecting line of the exterior surface 27a of the first gripper part 3 with the cutting surface 29; the cutting edge 25′ across the exterior surface 29a of the second gripper part 5 with the cutting surface 41.

It becomes obvious that the cutting edges 25, 25′ are positioned within the region of the adjoined exterior surfaces 27a and 29a of the first and second gripper parts 3, 5.

However, the invention preferably provides that the exterior surfaces 27a and 29a are not positioned in an imagined plane E, but instead form an acute angle at this imagined plane E.

FIG. 3 shows a cross-section through the first and second blade parts 9, 13 of the gripper parts 3 and 5. The cutting plane extends along the line III-III, which is drawn in FIG. 1. The same parts are denoted with the same reference symbols so that reference is made to the previous description in order to avoid redundancy. The cross-section illustrated in FIG. 3 is substantially enlarged—as in FIG. 2—as opposed to the illustration in FIG. 1.

The exterior surface 27 of the first blade part 9 and the exterior surface 29 of the second blade part 13 can be seen in the sectional view, and also the first cutting surfaces 31 and 31′ explained in FIG. 1. The first cutting surface 31 ends into the first cutting edge 23, and the first cutting surface 31′ ends into the cutting edge 23′. A second cutting surface 29′ falling off laterally toward the base attaches to the first cutting edge 23, and a second cutting surface 41′ rising laterally toward the top attaches to the first cutting edge 23′.

Thus, the first cutting edge 23 is formed by means of the intersecting line of the first cutting surface 31 with the second cutting surface 39′. The first cutting edge 23′ is formed by means of the intersecting line of the first cutting surface 31′ with the second cutting surface 41′.

FIG. 3 clearly shows that the first cutting edge 23 of the second blade part 9, and the second cutting edge 23′ of the second blade part 13 are positioned at a distance to the exterior surfaces 27 and 29, e.g. at an offset toward the right at a distance to the plane E indicated herein.

A comparison to the cutting edges illustrated in FIGS. 2 and 3 shows that the cutting edges 25, 25′ are formed by means of two cutting surfaces 27a and 39, and 29a and 41, which extend toward each other in a V-shaped manner, an include a comparatively acute angle. The cutting edges 23, 23′ are formed both by means of the cutting surfaces 31 and 39′ and by means of the cutting surfaces 31′ and 41′, which extend toward each other in a V-shaped manner, and include a larger angle.

The cutting edges 25, 25′ in the front area of the flush cutter 1 are therefore finer, and serve to separate thinner wires, than the cutting edges 23, 23′ in the first area positioned near the joint 7.

It becomes obvious from the explanations of FIGS. 1 to 3 that the flush cutter 1 has two blade parts 9 and 13, which have cutting edges 23, 23′ and 25, 25′ that are embodied differently, wherein the blades 23, 23′ are configured in a more solid manner, and are suitable for cutting thicker wires, than the blades 25, 25′ being configured in a finer manner.

Thus, wires of different diameters can be cut using the flush cutter 1 illustrated herein without any problems. It is not necessary to use flush cutters of varying configurations, because the flush cutter 1 illustrated herein has cutting sections 19 and 21 having different configurations.

The joint 7 of the flush cutter 1 is explained below in further detail based on FIGS. 4 and 5:

FIG. 4 shows the area of the joint 7 as a cross-section extending along the line A-A illustrated in FIG. 1. The first gripper part 3 and the second gripper part 5 are shown. The first gripper part 3 is equipped with a through opening 53, and the second gripper part 5 is equipped with a through opening 55. The two openings 53, 55 are flush with each other, and receive the base body 38 of the joint bolt 39, which is equipped with a collar 61. The same prevents that the joint bolt 39 can glide through the first and/or second through openings 55 or 53.

The base body 38 has an annular groove 63 on its exterior, while at least one recess, preferably also an annular groove 65, is provided on the interior of the through openings 53 and 55, wherein an area of the annular groove of the first through opening 53 may be associated with the first gripper part 3, and a second area of the second through opening 55 may be associated with the second gripper part 5. It is critical that the annular groove 63 is positioned on the exterior of the joint bolt 39, and that the annular groove 65 is positioned in the area of the first and second through openings 53 at the same level, at least in some sections, as measured in the direction of the center axis 67 of the joint bolt 39. In this manner an annular space 69 positioned in the interior is created in the area of the joint 7, in which a ring 71, preferably made of plastic, is provided. Preferably, the ring 71 is injection-molded. For this purpose at least one access channel 73 connected to the annular space 69, and open toward the exterior, is provided in the area of the joint 7, through which the plastic can be injected into the annular space 69. It is also conceivable to provide multiple access channels in order to press plastic into the annular space 69 across several areas.

The friction of parts moving against each other occurring in the area of the joint 7 is reduced by means of the ring 71. As can be seen from FIG. 2, the annular space 69 also extends radially toward the exterior as opposed to the center axis 67, thus having a diameter that is larger than that of the through openings 53 and 55. In this manner the first gripper part 3 contacts the second gripper part 5 only outside of the plastic ring 71 realized herein.

The joint 7 described herein can be produced in a very simple manner: the two gripper parts 3 and 5 and placed on top of each other such that the through openings 53 and 55 are flush in the gripper parts 3 and 5. The joint bolt 59 can then be inserted into the through openings 53 and 55, until the same abuts to the exterior of one of the gripper parts with its collar 61. At this point the joint bolt 39 is inserted into the through openings 53, 55 at the bottom, as shown in the example, so that the collar 61 is supported on the exterior of the second gripper part 5.

Subsequently, a plastic mass can be injected via the at least one access channel 73, in order to realize a ring 71 that has a cylindrical section, which extends across a certain height—as measured in the direction of the center axis 67. The height in this example is about one third of the mutual thickness of the two gripper parts 3 and 5. The ring 71 further has a more plate-shaped section extending radially toward the exterior, which is arranged within the contact area between the first gripper part 3 and the second gripper part 5, namely in a plane on which the center axis 67 is perpendicular. In this manner the contact surface of the two gripper parts 3 and 5 is reduced in the area of the joint 7.

Thus, the ring 71 reduces the friction between the two gripper parts 3 and 5 among each other overall, and the friction of these two gripper parts as opposed to the joint bolt 39.

The joint 7 can be produced in a cost-effective manner. The parts associated with the joint 7, the gripper parts 3 and 5, are connected to each other by means of the joint bolt 39. The joint bolt is secured in the through openings 53 and 55 from falling out by means of the injected ring 71. The joint 7 is characterized in that the friction of the parts connected to each other in the area of the joint are reduced to a minimum.

It becomes obvious from the explanations as to FIG. 4 that the embodiment of the ring 71 may be adjusted to the forces present in the joint 7 to a broad extent. It is therefore possible to provide a higher cylindrical section as measured in the direction of the center axis 67, than illustrated herein. It is also conceivable to modify the extension of the ring 71 as measured perpendicular to the center axis 67 in order to provide a more or less large plastic surface in the contact area between the first and the second gripper parts 3, 5, which serves for the reduction of the friction forces in the area of the joint 7.

The friction incidentally may also be influenced, particularly reduced, by means of the selection of special plastic materials.

The two gripper parts 5 and 3 are preferably produced of metal. Particularly preferred methods for the production are the so-called MIM method, the metal injection molding method, also referred to as the metal powder injection molding method.

During the production of the flush cutter 1, handle elements are attached to the gripper parts 3 and 5. Preferably, a stationary handle element is attached to one of the gripper parts, to the first gripper part 3 herein, which is disabled from carrying out any pivoting movements as opposed to the gripper part 3.

A method, in which the first handle element is integrally formed, preferably injected-molded to the first gripper part 3, is particularly preferred for the production of the pliers embodied as a flush cutter 1.

In a further step the first gripper part 3 can now be connected to the second gripper part 5, in that the joint bolt 39 is passed through the through openings 53 and 55 after connecting the gripper parts 3 and 5. The ring 71 is then injected to complete the joint 7.

It is shown herein that the two gripper parts 3 and 5 can also be previously assembled, and the joint bolt 39 can be previously inserted, and subsequently the first handle element can be attached, preferably injection-molded, to the first gripper part 3. A production method, in which the first handle element is integrally formed, particularly injection-molded, onto the first gripper part 3, and the ring 71 is injected into the area of the joint 7 in one process step, is particularly preferred.

Different plastic materials adjusted to the varying stresses of the handle element and of the ring 71 may also be used, and the injection-molding of the handle element and the injecting of the ring 71 can be realized using the so-called two-component injection molding method. It becomes obvious that the same plastic materials may, of course, also be used for the handle element and for the ring.

In a further step a parallelogram joint provided with these pliers 1 is then completed in that a coupling element is inserted. The same is attached preferably in the area of the through opening D1 at the first gripper part 3 in a pivoting manner. The other end of the coupling element is then pivot-connected to the second handle element. At a distance thereto, the second handle element is connected to the end 15′ of the actuator 15.

Furthermore, a spring element and a latch element are inserted before the first handle element is completed, particularly by means of attaching a cover, or a second half shell. The second handle element is completed by means of an associated part accordingly.

Preferably, a material that is particularly slip-proof is used for the handle elements in order to prevent slipping while handling the pliers. The material must be hard enough in order to absorb the forces occurring with the use of the pliers, and to transfer the same to the gripper parts 3 and 5.

It is also conceivable to equip the handle elements with areas of varying plastics, e.g. to utilize softer materials in the contact area of hand and fingers, in order to increase the user's comfort. In this case it is also quite possible to utilize different plastic materials for the production of the handle elements, and to process the same during the course of the two-component injection molding method.

The use of plastic materials for the handle elements is of particular advantage, because even with the use of metal during the production of the blade parts 3 and 5, the user is insulated from the same, and the risk of being electrocuted while handling the pliers is reduced to a minimum.

FIG. 5 shows the joint 7 between the two blade parts 3 and 5 in a cross-sectional illustration, wherein the section extends along the line B-B drawn in FIG. 1, and which is positioned in an imagined plane, in which the center axis 67 of the joint bolt 59 is also positioned. The same parts are denoted with the same reference symbols, thereby making reference to the description of the previous figures, particularly to FIG. 4.

In FIG. 5 the two blade parts 3 and 5 of the pliers 1 are also illustrated at a greatly enlarged cross-section along the line B-B shown in FIG. 1. The through opening 53 in the first blade part 3, and the through opening 55 in the second blade part 5 are positioned flush to each other, and receive the joint bolt 39, which is arranged in this example such that it abuts to the second blade part 5 with its collar 61 protruding radially across its circumference, e.g. is prevented from sliding through the two through openings 53 and 55. As already explained based on FIG. 4, the base body 38 of the joint bolt 39 has an annular groove on its exterior, while the interior of the through openings 53 and 55 has a recess so that the annular groove 65 is formed, into which a plastic mass in injected. A ring 71 is formed in this manner, which engages both into the annular groove 63 in the base body 38 of the joint bolt 39, and into the recesses, which are present in the through openings 53 and 55, and thus also in the blade parts 3 and 5. The ring 71 therefore engages in to the two blade parts 3 and 5, and into the joint bolt 39 so that the same can no longer be pushed out from the through openings 53 and 55 in the direction of its center axis 67. The two blade parts 3 and 5 are also secured by means of the ring 71.

It is additionally provided that the blade parts 3 and 5 are coupled to each other via a bayonet-like connector 75. This is realized in that a groove 77 extending across a circular arc is incorporated in one of the two blade parts, in this case in the second blade part 5. It may extend across the thickness of the second blade part 5. The groove 77 is equipped with a protrusion, at least in an area of its circular arc shaped extension, which protrudes radially toward the exterior into the groove as opposed to the center axis 67 of the joint bolt 59.

In order to realize the bayonet-like connector 75, the other blade part, in this case the first blade part 3, has a protrusion 81 extending parallel toward the center axis 67, and comprising a section that protrudes radially toward the interior in the direction of the center axis 67 on the side facing away from the base body of the blade part 3, and which acts as an abutment 83.

The length of the protrusion 81, and the thickness of the abutment 83 are selected such that the abutment 83 protruding radially toward the interior engages into a functional position of the connector 75 underneath the protrusion 79 so that both blade parts 3 and 5 are latched to each other.

In order to create a connection 75 of the type mentioned herein, at least one groove 77, and at least one protrusion 81 are provided, into which the groove 77 extends. Preferably, it is provided that two point symmetrical grooves 77 are provided in one of the blade parts, in this case the in the second blade part 5, which are curved in the manner of a circular arc. Accordingly, two protrusions 81 are to be provided at the other part, e.g. at the first blade part 3 herein, which are also embodied in the manner of a circular arc.

The side of the groove 77 on the first blade part 3 facing the same is embodied broad enough in one section—as measured perpendicular to the center axis 67—that the abutment 83 of the first blade part 3 can be inserted therein. This area of the groove 77 serving as the receiving section is arranged such that the protrusion 81 can engage into the receiving section of the groove 77 together with the abutment 83, when both blade parts 3 and 5 are placed on top of each other in their maximum opened functional position. If both blade parts 3 and 5 are then pivoted slightly into their closed position, the abutment 84 engages underneath the protrusion 79 of the groove 77 that protrudes radially toward the exterior so that the protrusion of the first blade part 3 is safely retained in the groove 77 of the second blade part 5.

It is preferably provided that if the two blade parts 3 and 5 are in their completely closed position, e.g. if the pliers are closed, the abutment 83 comes to rest completed underneath the protrusion 79, and the two blade parts 3 and 5 are optimally retained on top of each other by means of the connection 75. If the blade parts 3 and 5 of the pliers are slightly opened, they are held together by means of the protrusion 79 substantially located over the abutment 83 in the area of the connection 75. This results in an excellent stability of the connecting area of the blade parts 3 and 5 in the joint 7 while the pliers are being used.

The two blade parts 3 and 5 are held on top of each other exclusively by means of the ring 71 made of plastic, only in the maximum opened position of the pliers. Since the pliers are not utilized in this position, the user experiences no disadvantages. The abutment 83 embodied in a circular arc manner engages underneath the protrusion 79 as soon as the pliers are slightly closed, and are possibly utilized for work. However, particularly, if the pliers are opened across a certain area only, and must possibly exert high forces, the abutment 83 engages far beneath the protrusion 79 so that the joint 7 is extremely stable by means of the bayonet-like connection 75, and can absorb high forces.

The joint 7 of the pliers is characterized in that it is particularly low in friction, because a plastic ring 71 is provided in its interior. The same extends across the contact area between the two blade parts 3 and 5, and the joint bolt 59 of the joint 7, but also across an area of the contact surface between the blade parts 3 and 5. The friction forces can be reduced to a minimum particularly with the selection of suitable plastics, which preferably can also be processed by means of the injection molding method. This contributes to the fact that the forces necessary during the handling of the pliers are reduced to a minimum.

During the production of the pliers the plastic injection molding method is used to as large an extent as possible, wherein at least the production of the first handle element, and that of the ring 71 is possible in one mutual process step, even if different plastic materials are being used for the two plastic parts, which are adjusted to the various cases of stresses in the handle area, and in the area of the joint 7. In this case, two-component injection molding methods may be utilized.

Two-component injection molding methods can be utilized both for the more or less simultaneous production of handle elements and the ring 71, and for the production of the handle elements themselves, which may comprise plastics having different properties. On one hand, hard plastics are used, which absorb forces occurring during the use of the pliers, and which may have a reinforcement core made of metal. On the other hand, plastics preventing the user's hands from slipping off the handle elements 17 and 19, and which also have self-elasticity in order to reduce the stresses of the user's skin while using the pliers.

1-12. (canceled)

13. A flush cutter, comprising:
a first gripper part, having a first blade part with a first a blade;
a second gripper part having a second blade part with a second blade, the first and second blade parts pivotably connected at a joint;
wherein the first and second blades both have at least a first cutting portion and a second cutting portion,
the first cutting portion of each blade being proximate to the joint and having a first cutting edge formed by a pair of cutting surfaces extending toward each other in a V-shaped manner, and which is arranged at a distance to an exterior surface of a respective one of the first and second blade parts, the second cutting portion spaced from the joint and adjoining the first cutting portion on a side facing opposite the joint, having a second cutting edge with two cutting surfaces extending toward each other in a V-shaped manner, one of the two cutting surfaces coinciding with an exterior surface of the respective one of the first and second blade parts.

14. The flush cutter according to claim 13, wherein the exterior surfaces of first and second blade parts in the first cutting portion, and the exterior surface of the blade parts in the second cutting portion form an angle with each other.

15. The flush cutter according to claim 14, wherein the blade parts—as viewed from the bottom and the top—taper in the direction of a front end of the flush cutter opposite of the joint.

16. The flush cutter according to claim 15, wherein a tapering angle in the first cutting portion is smaller than in the second cutting portion.

17. The flush cutter according to claim 13, wherein the blade parts—as viewed from the side—taper from the joint in the direction of the front end of the flush cutter opposite of the joint.

18. The flush cutter according to claim 17, wherein a tapering angle in the first cutting portion is smaller than in the second cutting portion.

19. The flush cutter according to claim 13, further comprising a joint bolt and an injected ring.

20. The flush cutter according to claim 19, wherein the gripper parts each have a through opening receiving the joint bolt of the joint.

21. The flush cutter according to claim 19, wherein an interior of at least one of the through openings has at least one recess.

22. The flush cutter according to claim 21, wherein the at least one recess is an annular groove.

23. The flush cutter according to claim 19 wherein an exterior of the joint bolt has an annular groove.

24. The flush cutter according to claim 19, wherein a center axis of the through openings and that of the joint bolt coincide, and further wherein the at least one recess or the annular groove, respectively, are on the same level, at least in sections, on an interior of the through openings, and the annular groove on the exterior of the joint bolt—viewed in the direction of the center axis, such that an annular space is formed for the ring.

25. The flush cutter according to claim 24, further comprising an access channel open at least toward the exterior leads to the annular space.
